(19) United States
(12) Patent Application Publication
(10) Pub. No.: US 2026/0159776 A1
(43) Pub. Date: Jun. 11, 2026

(54) METHOD FOR PREPARING NON-TOXIC LIPOSOMES USING EMULSION-TO-LIPOSOME TRANSITION

(71) Applicant: KNU-INDUSTRY COOPERATION FOUNDATION, Chuncheon-si (KR)

(72) Inventor: Changhoon CHAI, Seoul (KR)

(21) Appl. No.: 19/195,097

(22) Filed: Apr. 30, 2025

(30) Foreign Application Priority Data
Dec. 10, 2024 (KR) 10-2024-0182813

(51) Int. Cl. C11B 3/16; C11B 3/12

(52) U.S. Cl. CPC C11B 3/16; C11B 3/12

(57) ABSTRACT

A method for preparing non-toxic liposomes involves a direct emulsion-to-liposome transition. This process eliminates the need for the use of toxic solvents such as chloroform and chloroform-methanol mixtures, allowing for the production of non-toxic liposomes through a simple and efficient process. As a result, the liposomes prepared by this method offer high economic feasibility, safety, and biocompatibility for applications in various fields, including food, cosmetics, and drug delivery. Additionally, they exhibit high encapsulation efficiency and excellent structural stability, maintaining their initial form and structure over an extended period.

### CROSS-REFERENCE TO RELATED APPLICATION

This application claims priority to Korea Patent Application No. 10-2024-0182813, filed Dec. 10, 2024, the contents of which is incorporated by reference in its entirety.

### TECHNICAL FIELD

The present invention relates to non-toxic liposomes and a method for preparing the same. Specifically, the present invention provides non-toxic liposomes that are safe for human use and can be applied in various fields, including food, cosmetics, drug delivery, and other biotechnology fields, and a method for preparing such liposomes.

### BACKGROUND OF THE INVENTION

Liposomes are artificial lipid vesicles composed of phospholipid bilayers capable of encapsulating various food substances. These liposomes offer significant advantages, such as protecting encapsulated substances from environmental stress, which helps maintain their stability and effectiveness. In particular, they enhance the functionality and bioavailability of encapsulated food substances, improving their nutritional value and efficacy. Therefore, liposomes are widely employed in food, cosmetic, pharmaceutical, and biotechnological applications.

Despite extensive research over the past two decades, the use of liposomes still faces several challenges and limitations: The use of liposomes for human applications has been limited due to concerns about toxicity and safety. Conventional methods for liposome preparation often require toxic solvents, such as chloroform and chloroform-methanol mixtures, which are not suitable for producing edible materials. Cholesterol is considered an essential component for enhancing liposome stability. However, conventional methods require the use of such toxic nonedible organic solvents for incorporating cholesterol with phospholipids (lecithin), because cholesterol and lecithin do not readily mix in their pure forms. Even after solvent removal, residual solvents make it practically impossible to use these liposomes in real-world applications. In addition, handling such toxic organic solvents requires strict safety measures and specialized equipment, which increases production costs and further limits commercial feasibility.

Additionally, the quantity of liposome produced is a critical factor for marketability. However, achieving high-yield, large-scale production of liposomes has remained challenging. Current methods, including conventional techniques (e.g., film hydration and reverse-phase evaporation) and newer approaches (e.g., supercritical fluid-based and microfluidic methods), often fall short of meeting the production scale required for food applications. Therefore, there is a growing need for a simple, scalable method for producing liposomes in large quantities.

### SUMMARY OF THE INVENTION

### Objective of the Invention

The primary objective of the present invention is to provide non-toxic liposomes and a preparation method thereof, which can be used safely in various fields, including food, cosmetics, and drug delivery, with high safety and human compatibility. Another objective of the present invention is to provide non-toxic liposomes and a preparation method of the same, which achieve high encapsulation efficiency and structural stability, thereby maintaining their initial form and structure over an extended period.

### Means for Solving the Problem

The method for preparing non-toxic liposomes according to the present invention comprises: an emulsion preparation step comprising the preparation of a water-in-oil (W/O) emulsion comprising phospholipids, oil, and water; a solvent addition step comprising the addition of an ethanol-water solution to the W/O emulsion to produce a liposome-containing mixture; an oil removal step comprising the separation and removal of the oil from the liposome-containing mixture, thereby obtaining a liposome-containing ethanol-water solution; and an ethanol removal step comprising the separation and removal of ethanol from the liposome-containing ethanol-water solution, thereby obtaining a liposome-containing aqueous solution.

In some embodiments, in the emulsion preparation step, phospholipids are chosen from plant-derived lecithin or animal-derived lecithin, and the oil is chosen from plant-derived oil or animal-derived oil.

In some embodiments, in the emulsion preparation step, a hydrophilic-lipophilic balance (HLB) of the phospholipids is from 1 to 7.

In some embodiments, in the emulsion preparation step, the W/O emulsion comprises 0.2 to 10% by weight of phospholipids.

In some embodiments, in the emulsion preparation step, the W/O emulsion comprises 25 to 90% by weight of oil and 5 to 70% by weight of water.

In some embodiments, in the emulsion preparation step, the W/O emulsion further comprises cholesterol.

In some embodiments, in the emulsion preparation step, the W/O emulsion contains 0.1 to 10% by weight of cholesterol based on the weight of the oil phase.

In some embodiments, in the solvent addition step, the ethanol-water solution is added in an amount of 20 to 200 parts by weight per 100 parts by weight of the W/O emulsion.

In some embodiments, in the solvent addition step, the ethanol-water solution comprises ethanol at a concentration of 20 to 80% by volume.

In some embodiments, in the emulsion preparation step, the W/O emulsion comprises a plurality of micelles.

In some embodiments, in the solvent addition step, upon addition of the ethanol-water solution to the W/O emulsion, the solubility of lecithin in the continuous phase decreases, allowing lecithin to migrate to the surface of the micelles to form phospholipid bilayers, thereby forming multiple liposomes.

In some embodiments, in the oil removal step, the separation is performed by centrifugation, and the liposome-containing mixture is phase-separated into an upper oil phase and a lower aqueous phase by centrifugation. The upper oil phase is removed, resulting in the collection of the lower aqueous phase containing the liposome-containing ethanol-water solution.

In some embodiments, in the ethanol removal step, the separation and removal are performed by vacuum distillation.

In some embodiments, in the ethanol removal step, the vacuum distillation is performed at a temperature of 5 to 100° C. and a pressure of 10 to 150 mbar.

In some embodiments, the encapsulation efficiency of the liposomes is at least 15%.

In some embodiments, the liposomes have a storage stability (S) of 35 to 100%, satisfying the following Equation 1:

$$S = {E}_{7 d} / {E}_{0 d}$$

where S represents the storage stability of the liposomes, E_{7d} represents the encapsulation efficiency after 7 days of storage at 25° C. and 1 atm, and E_{0d} represents the encapsulation efficiency immediately after preparation.

In some embodiments, the average particle size of the liposomes immediately after preparation is 0.05 to 3 μm.

In some embodiments, the light scattering analysis spectrum of the liposomes immediately after preparation shows a primary peak at 100 to 300 nm and a secondary peak at 1.5 to 3 μm.

In some embodiments, after 7 days of storage, the light scattering analysis spectrum of the liposomes shows a primary peak at 200 to 450 nm.

In some embodiments, the liposomes comprise cholesterol and show a primary peak at 100 to 300 nm and a secondary peak at 0.5 to 1.5 μm in the light scattering analysis spectrum immediately after preparation.

In some embodiments, the liposomes comprise cholesterol and, after 7 days of storage, exhibit a unimodal distribution with a primary peak at 150 to 300 nm in the light scattering analysis spectrum.

The non-toxic liposomes produced by the manufacturing method of the present invention utilize a direct emulsion-to-liposome transition, ensuring that the liposomes are free from toxicity. Unlike conventional methods that require toxic solvents such as chloroform or chloroform-methanol mixtures for cholesterol incorporation, the present invention achieves cholesterol incorporation without using such toxic nonedible solvents, significantly improving the safety of the resulting liposomes.

The direct emulsion-to-liposome transition makes the liposomes highly safe and biocompatible for use in various fields, including food, cosmetics, drug delivery, and other biotechnological applications.

Furthermore, the liposomes produced by the method of the present invention exhibit high encapsulation efficiency and excellent structural stability. In particular, the incorporation of cholesterol enhances the physical stability of the liposomes, allowing them to maintain their initial form and structure over an extended period.

### DESCRIPTION OF DRAWINGS

FIG. 1 is a schematic representation of liposome formation through the emulsion-to-liposome transition in the liposome preparation method according to the present invention.

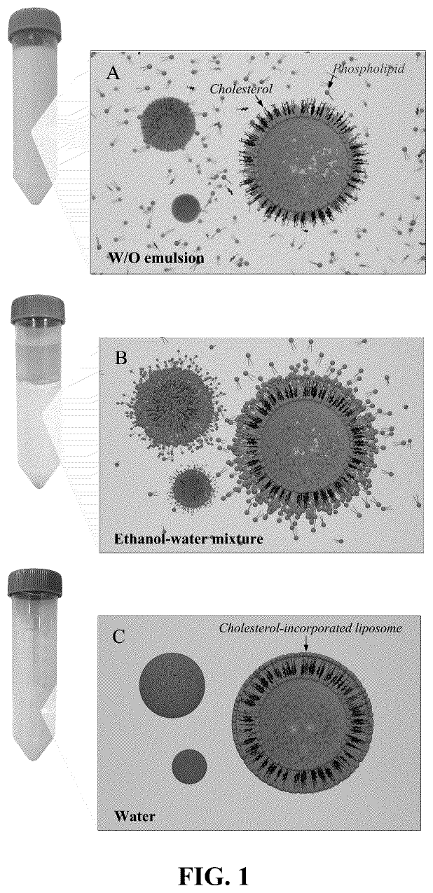

FIG. 2 is a graph showing the encapsulation efficiency of the liposomes in Example 1, at various concentrations of lecithin having an HLB value of 4 (p<0.05).

FIG. 3 is a graph showing the encapsulation efficiency of the liposomes in Example 1, at different ethanol-to-water ratios and with lecithin types (p<0.05).

FIG. 4 is a graph showing the encapsulation efficiency of the liposomes in Example 2, which were prepared using 2% by weight of lecithin having an HLB value of 3 and varying cholesterol concentrations (p<0.05).

FIG. 5 is a graph showing the storage stability of the liposomes (percentage of encapsulation efficiency at each time point compared to day 0) in Examples 1 and 2 (p<0.05).

FIG. 6 is a graph showing the size distribution of the liposomes in Examples 1 and 2 on day 0 and day 7, represented in (A) and (B), respectively.

FIG. 7 show images analyzing the nanoscale surface morphologies of the liposomes in Examples 1 and 2. Specifically: (A) shows an intact cholesterol-free liposome from Example 1; (B) shows an intact cholesterol-incorporated liposome from Example 2 (an empty arrow indicates water leakage); (C) shows a ruptured and evaporated cholesterol-free liposome from Example 1 (solid arrows indicate ruptured fragments); (D) shows a ruptured and evaporated cholesterol-incorporated liposome from Example 2 (solid arrows indicate ruptured fragments). The scale bar in the lower right corner of each image represents 200 nm.

FIG. 8 presents sequential SPM analysis images of the liposomes in Example 1. (A) to (D) illustrate the progressive merging of liposomes over time.

### METHOD FOR PREPARING NON-TOXIC LIPOSOMES

The method for preparing non-toxic liposomes according to the present invention comprises: an emulsion preparation step comprising the preparation of a water-in-oil (W/O) emulsion comprising phospholipids, oil, and water; a solvent addition step comprising the addition of an ethanol-water solution to the W/O emulsion to produce a liposome-containing mixture; an oil removal step comprising the separation and removal of the oil from the liposome-containing mixture, thereby obtaining a liposome-containing ethanol-water solution; and an ethanol removal step comprising the separation and removal of ethanol from the liposome-containing ethanol-water solution, thereby obtaining a liposome-containing aqueous solution.

By preparing a W/O emulsion containing phospholipids, adding an ethanol-water solution to form liposomes, and sequentially removing oil and ethanol, a liposome-containing aqueous solution can be obtained. This method enables the reproducible, mass production of structurally stable liposomes without using toxic nonedible solvents such as chloroform and chloroform-methanol mixtures, as in conventional methods.

The emulsion preparation step involves preparing a W/O emulsion with a continuous oil phase and a dispersed phase of multiple micelles encapsulating the central water core, comprising phospholipids.

The phospholipids comprise lecithin, including one or more selected from plant-derived or animal-derived lecithin. Preferably, the phospholipids comprise plant-derived lecithin, and the oil comprises plant-derived oil. In case where animal-derived lecithin is used, it is preferably similar in structure to plant-derived lecithin. This results in liposomes with excellent encapsulation efficiency and structural stability, maintaining their initial quality for extended periods.

Preferably, the phospholipids have a hydrophilic-lipophilic balance (HLB) of 1 to 7, more preferably 1 to 4, and even more preferably 2 to 4. This ensures the production of structurally stable liposomes that maintain their initial quality over time.

Specific examples of plant-derived lecithin include soy lecithin, sunflower lecithin, canola lecithin, corn lecithin, rice bran lecithin, hemp seed lecithin, flaxseed lecithin, pistachio lecithin, safflower lecithin, sesame lecithin, pumpkin seed lecithin, and moringa lecithin. Among these, soy lecithin is preferred.

Specific examples of plant-derived oils include canola oil, soybean oil, sunflower seed oil, sesame oil, flaxseed oil, pumpkin seed oil, cottonseed oil, grapeseed oil, olive oil, palm oil, avocado oil, coconut oil, walnut oil, almond oil, pecan oil, macadamia oil, rice bran oil, corn oil, hemp seed oil, camelina oil, shea butter oil, baobab oil, argan oil, moringa oil, chestnut oil, safflower seed oil, and pistachio oil. Among these, canola oil is preferred.

The composition ratio of the W/O emulsion is preferably set to improve the structural stability of the liposomes. The W/O emulsion may comprise 0.2 to 10% by weight of phospholipids, preferably 0.5 to 4%, and more preferably 2 to 4%. This ensures better encapsulation efficiency and structural stability of the liposomes.

The W/O emulsion may comprise 25 to 90% by weight of oil and 5 to 70% by weight of water, preferably 40 to 85% oil and 10 to 50% water, and more preferably 50 to 80% oil and 15 to 40% water. This also enhances encapsulation efficiency and structural stability.

### Incorporation of Cholesterol

Preferably, the W/O emulsion may further comprise cholesterol. If cholesterol is included, it affects not only the manufacturing process but also becomes part of the final liposome product. Specifically, cholesterol influences the formation of the phospholipid bilayer in liposomes, regulating membrane fluidity and enhancing stability. When cholesterol is incorporated during the liposome preparation process, it integrates into the liposomal membrane, improving the physical and chemical stability of the liposomes. Cholesterol occupies space within the phospholipid bilayer, modulating membrane fluidity to prevent it from becoming excessively fluid or rigid. Additionally, cholesterol intercalates between phospholipid molecules in the bilayer, increasing durability against external stresses (e.g., heat, pressure) and tightening the membrane, reducing leakage of encapsulated substances such as drugs.

When cholesterol is included in the W/O emulsion, the emulsion comprises 0.1 to 10% by weight of cholesterol based on the total lipid content, preferably from 0.2 to 5%, more preferably from 0.25 to 2%, and even more preferably from 0.75 to 1.5%. Meeting these conditions enhances the encapsulation efficiency and structural stability of the liposomes.

### Solvent Addition Step

The solvent addition step involves adding an ethanol-water solution to the W/O emulsion. When the ethanol-water solution is added, the solubility of lecithin in the continuous phase (oil) decreases, causing lecithin to migrate to the surface of the micelles, forming phospholipid bilayers. In this way, lecithin binding to the surface of micelles composed of a single phospholipid layer leads to the formation of liposomes with a phospholipid bilayer. This emulsion-to-liposome transition effectively forms liposomes without the use of toxic nonedible solvents such as chloroform and chloroform-methanol mixtures.

The amount of the ethanol-water solution used is sufficient to allow the lecithin present in the continuous phase (oil) of the W/O emulsion to sufficiently move and bind to the surface of the micelle to form a phospholipid bilayer, that is, to reduce the solubility of the lecithin in the continuous phase. For example, the ethanol-water solution is added in an amount of 20 to 200 parts by weight per 100 parts by weight of the W/O emulsion.

The ethanol concentration in the ethanol-water solution can be adjusted within a range but is preferably 20 to 80% by volume, more preferably 40 to 70%, and even more preferably 55 to 65%. Meeting these conditions ensures better encapsulation efficiency and structural stability of the liposomes.

### Oil Removal Step

The oil removal step involves removing oil from the liposome-containing mixture prepared in the solvent addition step to obtain a liposome-containing ethanol-water solution. Various methods are used for oil removal, with centrifugation being preferred. In this step, the mixture is phase-separated into an upper oil phase and a lower aqueous phase through centrifugation, and the upper oil phase is removed to obtain the lower aqueous phase containing liposomes. The centrifugation conditions are sufficient to achieve adequate phase separation, for example, at a speed at 1,000 to 20,000 rpm for 5 to 120 minutes.

### Ethanol Removal Step

The ethanol removal step involves separating and removing ethanol from the liposome-containing ethanol-water solution obtained in the oil removal step to obtain a liposome-containing aqueous solution. Various methods are used for ethanol removal, with distillation, specifically vacuum distillation, being preferred. The vacuum distillation conditions should be sufficient to completely remove ethanol, for example, at a temperature of 5 to 100° C. and a pressure of 10 to 150 mbar. The distillation time should be sufficient to ensure that all ethanol is removed.

The liposomes prepared according to the present invention exhibit high encapsulation efficiency and excellent structural stability. For example, the encapsulation efficiency of the liposomes may be at least 15%, and preferably at least 30%, with an upper limit of 100%.

### Storage Stability and Application of Liposomes

Furthermore, the liposomes prepared according to the present invention exhibit excellent storage stability. For example, the liposomes may have a storage stability (S) of at least 35%, specifically between 35% and 100%, as defined by the following Equation 1:

$$S = {E}_{7 d} / {E}_{0 d}$$

where S represents the storage stability of the liposomes, E_{7d} represents the encapsulation efficiency after 7 days of storage at 25° C. and 1 atm, and E_{0d} represents the encapsulation efficiency immediately after preparation.

In one embodiment of the present invention, the average particle size of the liposomes immediately after preparation is between 0.05 to 3 μm, specifically 0.1 to 3 μm.

In another embodiment, the light scattering analysis spectrum of the liposomes immediately after preparation indicates a particle size distribution with a primary peak corresponding to 100 to 300 nm and a secondary peak corresponding to 1.5 to 3 μm. After 7 days of storage, the spectrum shows a shift, with a primary peak corresponding to 200 to 450 nm.

Specifically, when the liposomes incorporate cholesterol, the particle size distribution measured by light scattering immediately after preparation shows a primary peak corresponding to 100 to 300 nm and a secondary peak corresponding to 0.5 to 1.5 μm. After 7 days of storage, the liposomes exhibit a unimodal particle size distribution with a primary peak corresponding to 150 to 300 nm, as determined by light scattering analysis.

The liposomes prepared according to the present invention can encapsulate a variety of substances and be applied in diverse fields. For example, the liposomes of the present invention are non-toxic and can be used in food, cosmetics, drug delivery, and other biotechnological applications.

As described above, the present invention provides a novel and simple method for preparing liposomes by manipulating the solubility of lecithin in a W/O emulsion, allowing lecithin molecules to migrate to emulsified water droplets and form liposomes. The emulsion-to-liposome transition involves key factors such as lecithin concentration, ethanol-to-water ratio, and cholesterol concentration, and optimal conditions for stable liposome formation have been established.

In particular, the present invention utilizes a direct emulsion-to-liposome transition, eliminating the use of toxic solvents and simplifying the process compared to conventional liposome preparation methods. This enables liposomes to be produced using general production means without the need for specialized equipment, making the method highly marketable in the food industry. Therefore, the present invention may be a promising candidate for large-scale liposome production in the food sector.

Additionally, the present invention provides a method for rapidly preparing liposomes in simple processes without additional steps. This enables the development of a marketable liposome production system for the controlled and sustained release of functional food substances, including vitamins, antioxidants, and antimicrobials.

### EXPERIMENTAL EXAMPLES

The following describes the present invention in detail through exemplary embodiments. However, these embodiments are provided to explain the invention more comprehensively, and the scope of the present invention is not limited to the following examples.

### Example 1

A glucose-containing phosphate buffer was prepared by dissolving glucose at a concentration of 60 mM in a 10 mM phosphate buffer (pH 7). The phosphate buffer was prepared by mixing sodium dihydrogen phosphate and disodium hydrogen phosphate in water to achieve pH of 7. Soy lecithin with an HLB value of 2, 3, or 4 (with 3 being the standard HLB value used in the experiment) was dissolved in canola oil at a concentration of 0.5, 1, 2, 3, or 4% by weight (with 2% by weight being the standard concentration used in the experiment) to prepare a lecithin-oil mixture. The glucose-containing phosphate buffer and the lecithin-oil mixture were homogenized using a homogenizer to prepare a W/O emulsion with a water-to-oil ratio of 40:100 by weight.

To reduce the solubility of lecithin in the continuous phase (oil phase) of the W/O emulsion and cause lecithin to migrate to the surface of micelles (phospholipid layers encapsulating the water-containing core) in the dispersed phase, thereby forming phospholipid bilayers, 20 g of the W/O emulsion was mixed with an ethanol-water solution at a 1:1 weight ratio to obtain a liposome-containing mixture. The ethanol concentration in the ethanol-water solution was adjusted to 40, 50, 60, or 70 vol % (with 60 vol % being the standard concentration used in the experiment) at 25° C. and 1 atm.

The liposome-containing mixture was subjected to centrifugation at 3,000 rpm for 30 minutes, resulting in phase separation into an upper oil phase and a lower aqueous phase. The lower aqueous phase, which contained the liposome-containing ethanol-water solution, was collected.

The liposome-containing ethanol-water solution was subjected to rotary evaporation at a temperature of 30° C. and a pressure of 60 mbar to remove ethanol, thereby obtaining a liposome-containing aqueous solution.

### Example 2

In the emulsion preparation step of Example 1, cholesterol was additionally dissolved in canola oil at concentrations of 0.25, 0.5, 0.75, 1, 1.5, or 2% by weight (with 1.5% by weight being the standard concentration used in the experiment) to prepare a lecithin-oil mixture. The remaining steps were performed in the same manner as in Example 1 to prepare a liposome-containing aqueous solution.

### Experimental Example 1: Evaluation of Encapsulation Efficiency

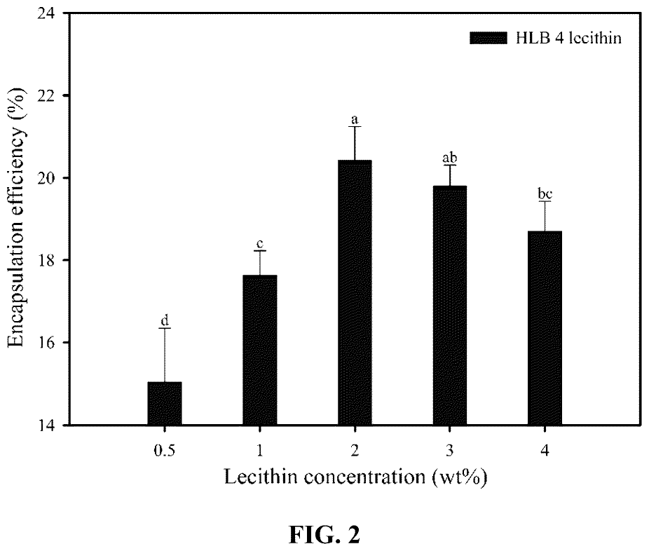

The encapsulation efficiency of the liposome-containing aqueous solutions prepared in Examples 1 and 2 was evaluated using the following method, and the results are shown in FIGS. 2 to 4.

The encapsulation efficiency of the liposomes in the samples was measured using Equations 1 to 5 below:

$${C}_{e} = {C}_{t} ( {V}_{e} + {V}_{e w} ) / {V}_{e} \qquad [ Equation 1 ]$$

$${V}_{l} = ( {C}_{o} \times {V}_{e w} ) / ( {C}_{{e}^{-}} {C}_{o} ) \qquad [ Equation 2 ]$$

$${M}_{t} = {C}_{t} ( {V}_{e} + {V}_{e w} ) / 1 \; 000 \qquad [ Equation 3 ]$$

$${M}_{o} = {C}_{o} ( {V}_{e w} + {V}_{l} ) / 1 \; 000 \qquad [ Equation 4 ]$$

$$Encapsulation efficiency ( \% ) = 100 ( {M}_{t} - {M}_{o} ) / {M}_{t} \qquad [ Equation 5 ]$$

In these equations:
Cₑ is the glucose concentration (mM) in the water phase within a W/O emulsion.
Cₜ is the total glucose concentration (mM) in a liposome dispersion.
Cₒ is the glucose concentration (mM) outside liposomes (the unencapsulated glucose concentration in the external water phase).
Vₑ is the water volume (mL) within a W/O emulsion.
V_{ew} is the water volume (mL) in an aqueous ethanol solution.
V₁ is the water volume leaked from emulsified water droplets and liposomes into the external water phase upon the addition of an aqueous ethanol solution.
Mₜ is the total amount (mmol) of glucose in a liposome dispersion.
Mₒ is the amount (mmol) of glucose outside liposomes.
Encapsulation Efficiency is the encapsulation efficiency (percentage of glucose encapsulated in liposomes relative to the total glucose in the solution).

Cₒ was measured by diluting 0.2 mL of the liposome solution with 0.2 mL of a 10 mM phosphate buffer and using the glucose detector (Green Cross MS, Yongin, Korea) and was then adjusted by a dilution factor of 2. Cₜ was measured by mixing 0.2 mL of the liposome solution with 0.2 mL of a 4 mM Triton X-100 solution, vigorously vortexing the mixture, and using the glucose detector. The value measured was adjusted by a dilution factor of 2. The values of Vₑ and V_{ew} were determined as follows: when 20 g of a water-in-oil (W/O) emulsion (6:4 oil-to-water weight ratio) was mixed with 20 g of an ethanol-water solution containing 40, 50, 60, and 70 vol % ethanol, Vₑ was fixed at 8 mL, and the corresponding values of V_{ew} were measured to be 13.11, 11.18, 9.16, and 7.04 mL, respectively.

### Experimental Results

### 1. Effect of Lecithin Concentration

The water-to-oil ratio (by weight) and lecithin concentration are essential factors in preparing a W/O emulsion. A W/O emulsion with a water-to-oil ratio exceeding 50% by weight was successfully prepared when the plant-based oil contained at least 2% by weight of lecithin. To ensure reliable reproducibility, the water-to-oil ratio was set at 40% by weight.

Referring to FIG. 2, the encapsulation efficiency increased as the lecithin concentration rose to 2% by weight when the liposomes were prepared by forming an emulsion using lecithin with an HLB value of 4, mixing it with a 60 vol % ethanol-water mixture, centrifuging, and removing ethanol through evaporation. As observed with other lecithins, the encapsulation efficiency did not significantly increase beyond a lecithin concentration of 2% by weight. Therefore, the standard lecithin concentration was determined to be 2% by weight.

2. Effect of Lecithin Type (HLB value) and Ethanol-to-Water Ratio

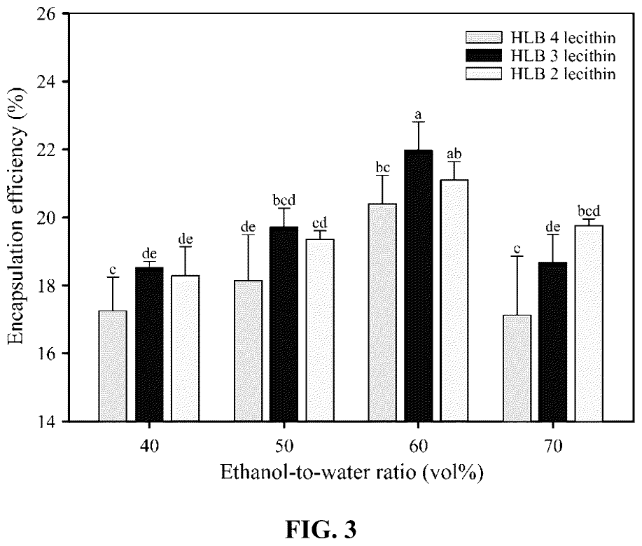

Referring to FIG. 3, the optimal ethanol-to-water ratio was identified as one that effectively separates the oil phase while facilitating the migration of lecithin molecules within the oil phase of the W/O emulsion, ultimately leading to liposome formation. Increasing the ethanol-to-water ratio in the mixture added to the W/O emulsion to 60 vol % gradually improved the encapsulation efficiency. However, increasing the ratio beyond 60 vol % did not result in further improvement.

As shown in FIG. 3, the encapsulation efficiency was also influenced by the type of lecithin. Lecithin with an HLB value of 3 demonstrated higher encapsulation efficiency compared to other types of lecithin, especially at an ethanol-to-water ratio of 60 vol %. Consequently, the optimal ethanol-to-water ratio and lecithin type were determined to be 60 vol % and the lecithin with an HLB value of 3, respectively.

### 3. Effect of Cholesterol Concentration

The lecithin molecules in the liposome membrane (phospholipid bilayer) exhibit mobility, making the membrane fluidic. This fluidity enables liposomes to merge with cells and transport encapsulated substances into them. However, this inherent mobility also accelerates the coalescence and disruption of liposomes in the absence of stabilizing modulators. Cholesterol acts as a stabilizing modulator by binding adjacent lecithin molecules within the bilayers and connecting them across the inner and outer layers. However, cholesterol and lecithin do not readily mix in their pure forms.

Conventional methods address this issue by dissolving both in organic solvents such as chloroform and chloroform-methanol mixtures. However, these pose safety concerns, particularly in the food industry, as they may not be completely removed through evaporation. In addition, handling such toxic solvents requires strict safety measures and specialized equipment, which increases production costs and further limits commercial feasibility.

Lecithin and cholesterol can be fully dissolved in plant-based oils at a combined concentration of up to 5% by weight. Therefore, cholesterol and lecithin were directly added to the plant-based oil and used to prepare liposomes.

To investigate the effect of cholesterol concentration on liposome formation, cholesterol was added to the oil phase at concentrations ranging from 0 to 2% by weight, along with lecithin having an HLB value of 3 at 2% by weight and this mixture was used to prepare cholesterol-incorporated liposomes.

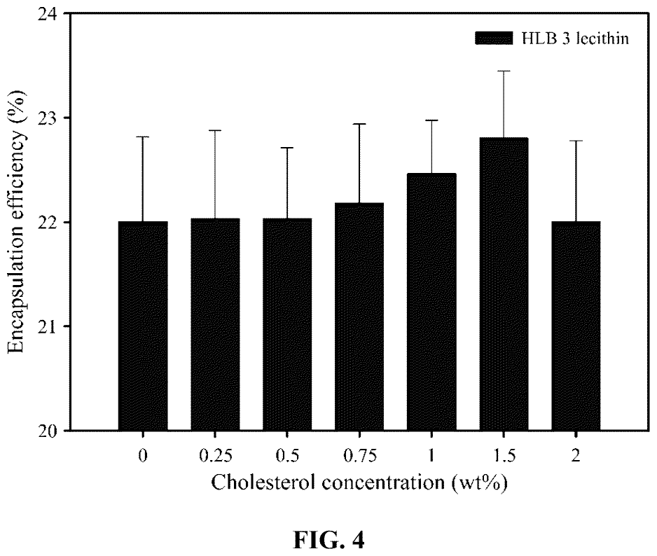

Referring to FIG. 4, the encapsulation efficiency increased when cholesterol was included, particularly at 1% and 1.5% by weight. The increase in encapsulation efficiency at these concentrations indicates that cholesterol was incorporated into the lecithin-based phospholipid bilayers of the liposomes formed from the W/O emulsion. The highest encapsulation efficiency achieved was approximately 22.8% at a cholesterol concentration of 1.5% by weight. This value is considerably high compared to conventional thin-film hydration methods, which typically provide an encapsulation efficiency of 10 to 15% unless small amounts of the aqueous phase are used. Conversely, at a high concentration of 2% by weight, the encapsulation efficiency decreased.

Due to its higher and more consistent encapsulation efficiency compared to other concentrations, 1.5% by weight of cholesterol was selected as the standard concentration for subsequent experiments.

### Experimental Example 2: Evaluation of Storage Stability

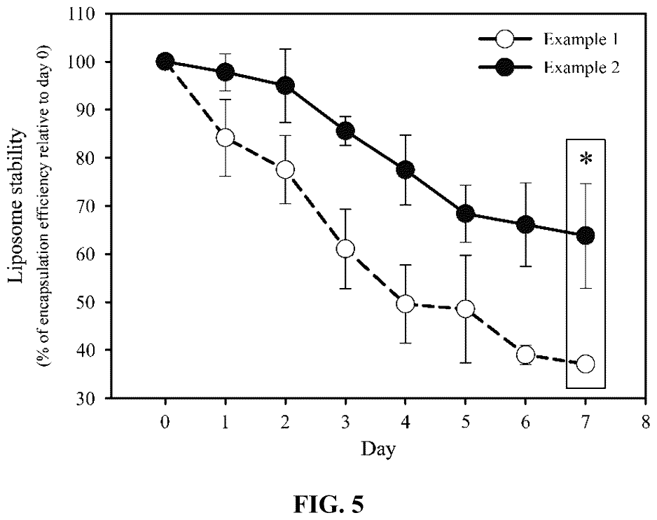

The storage stability of the liposomes in Examples 1 and 2 was evaluated using the following method, and the results are shown in FIG. 5.

Each sample was stored for 7 days, and the encapsulation efficiency of each sample was measured daily using the method described in Experimental Example 1. The storage stability of the liposomes was evaluated as the percentage ratio of the encapsulation efficiency measured on a given day to the encapsulation efficiency measured on day 0.

Referring to FIG. 5, the liposomes made of only lecithin, prepared in Example 1 (i.e., cholesterol-free liposomes), exhibited a time-dependent reduction in stability, reaching approximately 37% after one week. This reduction was attributed to coalescence and disruption over time. In contrast, the liposomes incorporating cholesterol, prepared in Example 2 (i.e., cholesterol-incorporated liposomes), exhibited significantly improved stability, maintaining approximately 64% of the initial encapsulation efficiency after one week. These results indicate that the incorporation of cholesterol into the phospholipid bilayer stabilizes the liposomal structure, mitigating disruption and prolonging the lifespan of the liposomes.

### Experimental Example 3: Measurement of Size Distribution and Zeta Potential of Liposomes

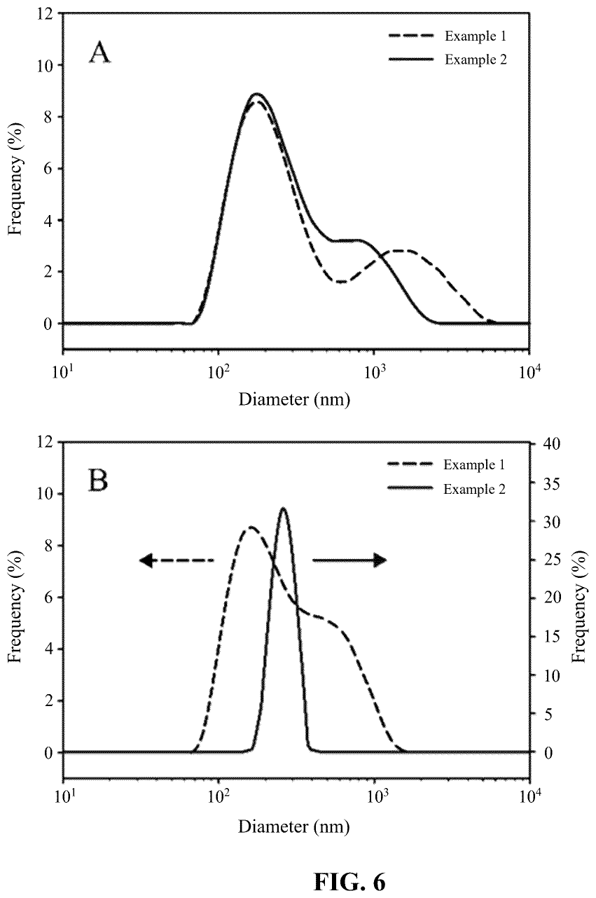

The size distribution and zeta potential of the liposomes in Examples 1 and 2 were measured using the following method, and the results are shown in FIG. 6 and Table 1.

Samples from Examples 1 and 2, prepared under standard conditions, were stored at room temperature, and their size distributions, polydispersity indices (PDIs), and zeta potentials were measured on days 0 and 7. The measurements were conducted using dynamic light scattering (DLS) and electrophoretic light scattering (ELS) on a Malvern Zetasizer Nano ZSP (Malvern Panalytical, Malvern, UK). The refractive index and absorption value were set to 1.45 and 0.001, respectively, based on the manufacturer's guidelines.

Referring to FIG. 6, on day 0, the liposomes in Example 1 (i.e., cholesterol-free liposomes) exhibited a bimodal size distribution with two distinct peaks. In contrast, liposomes in Example 2 (i.e., cholesterol-incorporated liposomes), displayed a bimodal distribution with some overlap between the primary and secondary peaks, indicating that the inclusion of cholesterol contributed to a more uniform size distribution.

Referring to Table 1, the zeta potentials of the cholesterol-free liposomes and the cholesterol-incorporated liposomes on days 0 and 7 were measured as −74.9 mV and −79.8 mV, respectively, in a 10 mM phosphate buffer (pH 7). The zeta potential is influenced by factors such as ionic strength, pH, and encapsulated materials. In the 10 mM phosphate buffer (pH 7), both the cholesterol-free liposomes and the cholesterol-incorporated liposomes exhibited zeta potentials below-30 mV, indicating predominant electrostatic repulsion and stable dispersion. As previously reported, cholesterol incorporation reduces the zeta potential of liposomes. Consistent with this, the cholesterol-incorporated liposomes showed a lower zeta potential than the cholesterol-free liposomes (Table 1), indicating successful cholesterol incorporation via the emulsion-to-liposome transition.

Additionally, on day 7, the cholesterol-free liposomes exhibited a unimodal size distribution. During storage, the liposomes comprising the secondary peak on day 0 were disrupted, and some of those comprising the secondary peak on day 0 merged into the primary peak on day 7, increasing the average diameter from 229.9 nm to 329.6 nm. The PDI decreased from 0.435 to 0.360.

The cholesterol-incorporated liposomes on day 7 did not exhibit the secondary peak observed on day 0 and displayed a distinct unimodal size distribution. As a result, the PDI significantly decreased from 0.417 to 0.261, and the average diameter increased from 232.0 nm to 270.6 nm, as shown in Table 1. Considering the high storage stability of the cholesterol-incorporated liposomes (FIG. 5), it is presumed that the unimodal peak mainly consists of cholesterol-incorporated liposomes.

TABLE 1
Mean diameters, polydispersity indices (PDIs), and zeta potentials of Chol-free and
Chol-inc liposomes prepared via the ELT method, measured on days 0 and 7 of storage

| | | Mean diameter (nm)/Volume percentage (%) | | | Poly-dispersity | Zeta |
|---|---|---|---|---|---|---|
| | | Primary | Secondary | | index | potential |
| Day | Class | peak | peak | Overall^{†} | (PDI) | (mV) |
| 0 | Example 1 | 229.9^{a} ± 5.0/ | 2,302.7 ± 599.0/ | 860.6 ± 236.8/ | 0.435^{c} ± 0.036 | −74.9^{b} ± 1.9 |
| | | 70.0 ± 2.7 | 30.0 ± 2.7 | 100 | | |
| | Example 2 | 232.0^{a} ± 26.8/ | 857.7* ± 143.4/ | 418.9* ± 39.1/ | 0.417^{bc} ± 0.03 | −79.8^{a} ± 2.3 |
| | | 70.0 ± 9.9 | 30.4 ± 9.9 | 100 | | |
| 7 | Example 1 | 329.6^{c} ± 5.1/ | ND^{‡} | N/A^{§} | 0.360^{b} ± 0.002 | −73.5^{b} ± 1.7 |
| | | 100 | | | | |
| | Example 2 | 270.6^{b} ± 9.1/ | ND^{‡} | N/A^{§} | 0.261^{a} ± 0.058 | −79.1^{a} ± 2.5 |
| | | 100 | | | | |

^{†}The overall mean diameter is the volume-weighted mean of both the mean diameters of both the primary and secondary peaks.
^{‡}ND (Not Detected) indicates that a secondary peak was absent on day 7.
^{§}N/A (Not Applicable) indicates that a secondary peak was absent, making measurement not applicable.
Different letters (a-c) within the same characteristic (mean diameter, PDI, or zeta potential) indicate significant differences (p < 0.05) as determined by one-way ANOVA followed by Duncan's multiple range test for post-hoc comparisons.
Asterisk (*) within the same characteristic (the mean diameter of the secondary peak or the overall mean diameter) indicates a significant difference (p < 0.05) as determined by the independent-samples t-test.

### Experimental Example 4: Nanoscale Surface Morphology Analysis

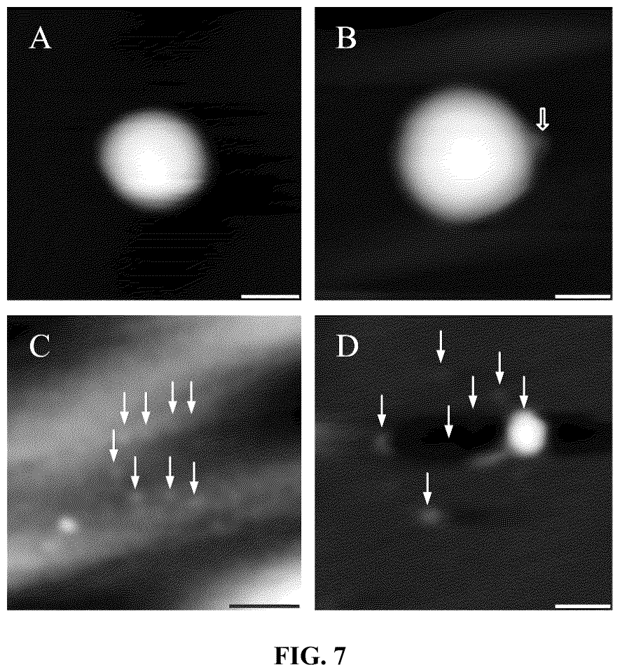

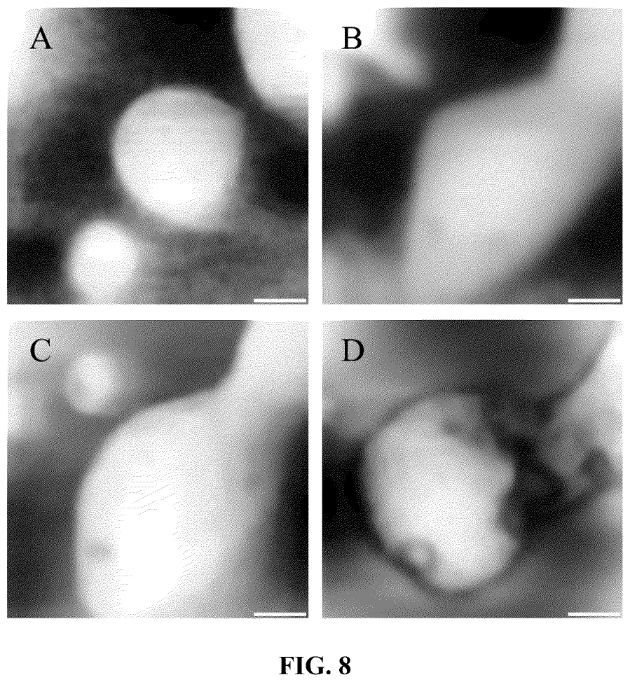

The nanoscale surface morphologies of the liposomes in Examples 1 and 2 were analyzed using the following method, and the results are shown in FIGS. 7 and 8.

The samples were applied to freshly cleaved mica disks (10 mm diameter, Probes, Seoul, Korea) and incubated for 30 minutes to allow the liposomes to adsorb onto the mica surface. The mica disks were then spun at 400 rpm using a spin coater (SCK-300P, Intras Scientific, Ridgefield Park, NJ, USA). The liposomes adsorbed onto the mica surface were analyzed using a dynamic mode scanning probe microscope (SPM) (EasyScan2, Nanosurf, Liestal, Switzerland) with a FortA silicon probe (nominal spring constant: 1.6 N/m, contact radius: <10 nm, AppNano, Mountain View, CA, USA). The acquired morphological images were processed using the Scanning Probe Image Processor software version 6.7 (Image Metrology, Lyngby, Denmark).

Referring to FIGS. 7 and Table 1, spherical liposomes with diameters ranging from 230 to 270 nm flattened into lenticular structures due to gravity when deposited onto the mica surface, leading to discrepancies between the size distribution and surface morphology analysis.

Referring to (A) and (B) of FIG. 7, the surface morphologies of the cholesterol-free liposomes in Example 1 and the cholesterol-incorporated liposomes in Example 2 did not show significant differences.

Referring to (C) and (D) of FIG. 7, during the SPM analysis, a probe with a contact radius of less than 10 nm was applied, causing the liposomes to rupture. The water encapsulated within the liposomes leaked and evaporated, leaving residual fragments. This observation provides direct evidence that the structures formed through the emulsion-to-liposome transition are indeed liposomes, rather than oil-in-water colloids.

Despite the similarities in nanoscale surface morphologies, the rupturing behavior of the cholesterol-free liposomes and the cholesterol-incorporated liposomes was markedly different. Referring to (B) of FIG. 7, the cholesterol-incorporated liposomes ruptured more easily under repeated probe oscillations during SPM analysis, resulting in water leakage. (B) and (D) of FIG. 7 show that it took approximately 25 minutes to rupture the cholesterol-incorporated liposomes and leave residual fragments.

In contrast, the cholesterol-free liposomes remained intact even under extreme probe oscillations, where the probe penetrated the liposomes and reached the mica surface. Referring to (A) and (C) of FIG. 7, it took approximately 2 hours for the cholesterol-free liposomes to leave residual fragments. This result may be attributed to the self-assembly of phospholipids in the penetrated regions of the cholesterol-free liposomes, preventing water evaporation.

Referring to FIG. 8, during SPM scanning, it was observed that the cholesterol-free liposomes merged with neighboring liposomes when displaced by the probe. This phenomenon was not observed in the cholesterol-incorporated liposomes, suggesting that the differences in rupturing behaviors are related to the properties of the liposomal membranes.

The incorporation of cholesterol stiffens liposomes, making them more susceptible to rupture under mechanically induced stress from the probe. Conversely, the phospholipids in the cholesterol-free liposomes, unrestricted by cholesterol, exhibit greater fluidity, providing resistance to rupture. Furthermore, the fluidity of the cholesterol-free phospholipids likely promoted liposome merging.

All experiments were conducted in at least triplicate to ensure reliability and reproducibility. Statistical analysis was performed using a one-way analysis of variance (ANOVA) followed by Duncan's multiple range test for post-hoc comparisons. The independent-samples t-test was used for comparisons between two groups. Statistical significance was set at p<0.05. All statistical analyses were performed using SPSS Statistics version 26 (IBM Corporation, Armonk, USA).

1. A method for preparing non-toxic liposomes, comprising:
a) an emulsion preparation step comprising the preparation of a water-in-oil (W/O) emulsion comprising lecithin, oil, and water;
b) a solvent addition step comprising the addition of an ethanol-water mixture to the W/O emulsion to produce a liposome-containing mixture;
c) an oil removal step comprising the separation and removal of the oil from the liposome-containing mixture, thereby obtaining a liposome-containing ethanol-water mixture; and
d) an ethanol removal step comprising the separation and removal of the ethanol from the liposome-containing ethanol-water mixture, thereby obtaining a liposome-containing aqueous solution.

2. The method of claim 1, wherein in the emulsion preparation step, the lecithin has a hydrophilic-lipophilic balance (HLB) of 1 to 7.

3. The method of claim 1, wherein in the emulsion preparation step, the W/O emulsion comprises 0.2 to 10% by weight of lecithin.

4. The method of claim 1, wherein in the emulsion preparation step, the W/O emulsion comprises 25 to 90% by weight of oil and 5 to 70% by weight of water.

5. The method of claim 1, wherein in the emulsion preparation step, the W/O emulsion further comprises cholesterol.

6. The method of claim 5, wherein in the emulsion preparation step, the W/O emulsion comprises 0.1 to 10% by weight of cholesterol.

7. The method of claim 1, wherein in the solvent addition step, the ethanol-water mixture is added in an amount of 20 to 200 parts by weight per 100 parts by weight of the W/O emulsion.

8. The method of claim 1, wherein in the solvent addition step, the ethanol-water mixture contains ethanol at a concentration of 20 to 80% by volume.

9. The method of claim 1, wherein in the emulsion preparation step, the W/O emulsion comprises a plurality of micelles.

10. The method of claim 9, wherein in the solvent addition step, a plurality of liposomes is formed by the migration of lecithin to the surface of the micelles and the formation of phospholipid bilayers, as the solubility of lecithin in the continuous phase decreases upon the addition of the ethanol-water mixture to the W/O emulsion.

11. The method of claim 1, wherein in the oil removal step, the separation is performed by centrifugation, and the liposome-containing mixture is phase-separated into an upper oil phase and a lower aqueous phase by centrifugation, and the upper oil phase is removed to obtain the liposome-containing aqueous solution.

12. The method of claim 1, wherein in the ethanol removal step, the separation and removal are performed through reduced pressure distillation.

13. The method of claim 12, wherein in the ethanol removal step, the reduced pressure distillation is performed at a temperature of 5 to 100° C. and a pressure of 10 to 150 mbar.

14. A liposome prepared by the method of claim 1.

15. The liposome of claim 14, wherein an encapsulation efficiency of the liposome is 15% or higher.

16. The liposome of claim 14, wherein a storage stability (S) of the liposome is 35% or higher according to the following Equation 1:
$$S = {E}_{7 d} / {E}_{0 d} \qquad [ Equation 1 ]$$
wherein S represents the storage stability of the liposome, E_{7d} represents the encapsulation efficiency after storage for 7 days under conditions of 25° C. and 1 atm, and E_{0d} represents the encapsulation efficiency immediately after preparation.
